(19) United States
(12) Patent Application Publication
(10) Pub. No.: US 2025/0301391 A1
(43) Pub. Date: Sep. 25, 2025

(54) Seamless Switching of IPsec Tunnels

(71) Applicant: Google LLC, Mountain View, CA (US)

(72) Inventors: Po-Chun Lee, Sunnyvale, CA (US); Chih-Wei Chen, New Taipei City (TW)

(73) Assignee: Google LLC, Mountain View, CA (US)

(21) Appl. No.: 19/229,529

(22) Filed: Jun. 5, 2025

Related U.S. Application Data
(60) Provisional application No. 63/815,065, filed on May 30, 2025.

(51) Int. Cl. H04W 40/02; H04L 9/08; H04L 9/40

(52) U.S. Cl. CPC H04W 40/02; H04L 9/0891; H04L 63/0485

(57) ABSTRACT

This document describes aspects of seamless switching of Internet Protocol security (IPsec) tunnels between subsystems within a user device. In aspects, the described systems and methods can initiate a child Security Association (SA) rekeying process to establish a new IPsec tunnel without interrupting a data exchange on an active IPsec tunnel. The described aspects may enable continuous communication while the data exchanged is migrated between the IPsec tunnels. In some cases, both the old and new child SAs coexist temporarily during the rekeying process, allowing for uninterrupted data flow and ensuring that security measures, such as anti-replay checks, remain effective. As such, the transitions of the data can be completed without data loss, as the subsystems handle the transfer of data packets over both IPsec tunnels. The described aspects are particularly beneficial for devices that switch between high-performance and low-power hardware subsystems, enabling the optimization of performance and energy efficiency.

### CROSS-REFERENCE TO RELATED APPLICATION

This application claims the benefit of U.S. Provisional Patent Application Ser. No. 63/815,065 filed on May 30, 2025, the disclosure of which is incorporated by reference herein in its entirety.

### SUMMARY

This document describes aspects of seamless switching of Internet Protocol security (IPsec) tunnels between subsystems within a user device. The described systems and methods for seamless switching can initiate a child Security Association (SA) rekeying process to establish a new IPsec tunnel without interrupting a data exchange on an active IPsec tunnel. The described aspects may enable continuous communication while the data exchanged is migrated between the IPsec tunnels. In some cases, both the previously existing and newly established child SAs coexist temporarily during the rekeying process, allowing for uninterrupted data flow and ensuring that security measures, such as anti-replay checks, remain effective. As such, the transitions of the data can be completed without data loss, as the subsystems handle the transfer of data packets over both IPsec tunnels. These aspects can be particularly beneficial for devices that switch between high-performance and low-power hardware subsystems, enabling the optimization of performance and energy efficiency.

In some aspects, a method for seamless switching of IPsec tunnels includes maintaining, on a user device, transmission of data through a first IPsec tunnel on a first subsystem using a first security association. The method initiates a rekeying process of an internet key exchange (IKE) client with an IKE server to establish a second security association, the IKE server external to the user device. Based on a second security association generated from the rekeying process, a second IPsec tunnel is established on a second subsystem, the second IPsec tunnel using the second security association. The method also transmits a portion of the data through the second IPsec tunnel on the second subsystem and initiates deactivation of the first IPsec tunnel on the first subsystem. The transmission of the data is then transitioned from the first IPsec tunnel on the first subsystem to the second IPsec tunnel on the second subsystem and the first IPsec tunnel on the first subsystem is deactivated after ceasing to transmit the data through the first IPsec tunnel on the first subsystem.

This Summary is provided to introduce simplified concepts of seamless switching of IPsec tunnels, which are further described below in the Detailed Description and are illustrated in the Drawings. This Summary is not intended to identify essential features of the claimed subject matter, nor is it intended for use in determining the scope of the claimed subject matter.

### BRIEF DESCRIPTION OF THE DRAWINGS

The details of one or more aspects of managing and switching IPsec tunnels seamlessly between different subsystems are described throughout the disclosure with reference to the Drawings. The use of the same reference numbers in different instances in the description and the figures indicates same or similar elements:

FIG. 1 illustrates an example operating environment that includes a user device in which aspects of systems for managing and switching IPsec tunnels seamlessly between different subsystems can be implemented;

FIG. 2 illustrates an example network environment in which the user device of FIG. 1 communicates through a wireless network;

FIG. 3 illustrates an example ladder diagram of communication and data flow steps for switching IPsec tunnels seamlessly between different subsystems;

FIG. 4 illustrates an example method of managing and switching IPsec tunnels seamlessly between different subsystems; and

FIG. 5 illustrates an example electronic device that may implement techniques of managing and switching IPsec tunnels seamlessly between different subsystems.

### DETAILED DESCRIPTION

A common challenge in using IPsec and IKE is managing sequence numbers and anti-replay mechanisms, especially when switching between different systems or subsystems for IPsec tunnels with service continuity. Switching between IPsec tunnels during data transmission can lead to latency issues and potential security risks. In preceding techniques, this process involves stopping the IPsec tunnel on the current subsystem, retrieving the latest sequence number, and then re-establishing the tunnel on the new subsystem. This transition must be handled carefully to avoid latency issues caused by a loss of continuity in the data transmission. Additional risk can occur if malicious actors are attempting replay attacks. A replay attack is a cybersecurity threat where a malicious actor intercepts a legitimate data transmission, captures it, and then retransmits that same data at a later time to gain unauthorized access to a system or perform actions as if they were the approved original sender. In accordance with RFC 4301, IPsec tunnels use sequence numbers and anti-replay mechanisms to ensure the integrity and authenticity of data packets. As noted, a key challenge in managing these tunnels is maintaining sequence number continuity and preventing replay attacks, particularly when switching between different subsystems within the device. Preceding solutions often require multiple handshakes and complete cessation of the IPsec tunnel during the switch, which can lead to service interruptions and increased latency, even within a single device.

In contrast with the preceding techniques, this disclosure describes aspects of seamless IPSec tunnel switching that may enable continuous and uninterrupted data transfer while maintaining security. In various aspects, the methods and systems for seamless switching of IPsec tunnels can be implemented between different hardware subsystems within the same device. This may be particularly relevant in scenarios in which a device, such as a mobile system, utilizes a high-performance hardware subsystem for processing heavy data workloads and a low-power subsystem for energy efficiency during idle periods.

In aspects, the described systems and methods may trigger a child security association (SA) rekeying process while allowing an existing IPsec tunnel and the new child SA tunnel to coexist temporarily. This dual-state approach may facilitate a stateless and uninterrupted transition, as the system can establish the new IPsec tunnel without fully terminating the existing IPsec tunnel. During this period, the existing IPsec tunnel continues to send and receive data packets, enabling continuous service and avoiding disruptions. After the system establishes the new IPsec tunnel, any packets still in transit via the existing IPsec tunnel can be successfully received, ensuring no loss of data during the transition. The system may also maintain sequence number continuity and prevent replay attacks, offering a seamless switch between subsystems while optimizing device performance, energy efficiency, and security.

In aspects, the described systems and methods can initiate a child Security Association (SA) rekeying process to establish a new IPsec tunnel without interrupting a data exchange on an active IPsec tunnel. The described aspects may enable continuous communication while the data exchanged is migrated between the IPsec tunnels. In some cases, both the previously existing and newly established child SAs coexist temporarily during the rekeying process, allowing for uninterrupted data flow and ensuring that security measures, such as anti-replay checks, remain effective. As such, the transitions of the data can be completed without data loss, as the subsystems handle the transfer of data packets over both IPsec tunnels. The described aspects are particularly beneficial for devices that switch between high-performance and low-power hardware subsystems, enabling the optimization of performance and energy efficiency.

This document describes apparatuses and techniques for seamless switching of IPsec tunnels, which may prevent data loss, protect from replay attacks, and allow for user devices to operate more efficiently. The following discussion describes an operating environment, example implementations of various test circuitry and wrappers, and example methods that may be implemented with for seamless switching of IPsec tunnels. In the context of the present disclosure, reference is made to the operating environment by way of example only.

### Example Environment

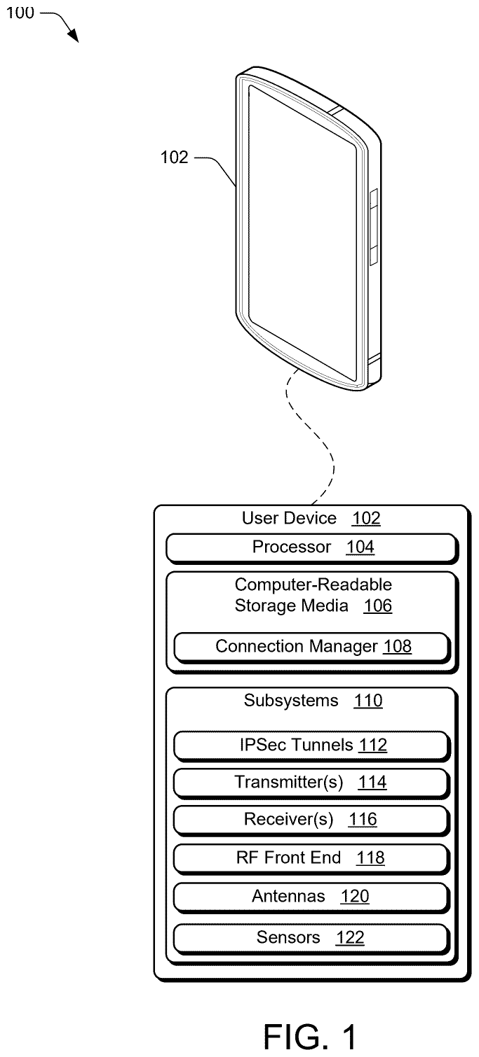

FIG. 1 illustrates an example environment 100 in which user device 102 may implement aspects of managing and switching IPsec tunnels seamlessly between different subsystems as described herein. In some implementations, the user device 102 can be configured to manage IPsec tunnels between different subsystems. For example, one or more instances of managing and switching IPsec tunnels seamlessly between different subsystems may be implemented in any suitable electronic device, system, or apparatus, which may include a smart-phone, a tablet computer, a laptop computer, a netbook, a gaming console, a desktop computer, a server computer, a wearable computing device (e.g., smart-watch), a broadband router (e.g., mobile hotspot), a mobile station (e.g., fixed- or mobile-STA), a mobile communication device, a user equipment, an entertainment device, a personal media device, a media playback device, a health monitoring device, a drone, a camera, smart-glasses, a phone-tablet, a wearable computer, a multimedia dongle, a set-top box, a vehicle based computing system, a navigation device, an aviation computing system, a home automation device, a security system controller, an Internet home appliance capable of wireless Internet access and browsing, an IoT device, and/or other types of electronic devices.

The user device 102 includes one or more processors 104 and computer-readable media 106, which may include memory media or storage media. The processor 104 may be implemented as a general-purpose processor (e.g., of a multicore central-processing unit (CPU) or application processor (AP)), an application-specific integrated circuit (ASIC), or a system on chip (SoC) with other components of the user device 102 integrated therein. The computer-readable media 106 can include any suitable type of memory media or storage media, such as read-only memory (ROM), programmable ROM (PROM), random access memory (RAM), dynamic RAM (DRAM), static RAM (SRAM), or Flash memory. In the context of this discussion, the computer-readable media 106 of the user device 102 is implemented as at least one hardware-based or physical storage device, which does not include transitory signals or carrier waves. Applications, firmware, and/or an operating system (not shown) of the user device 102 can be embodied on the computer-readable media 106 as processor-executable instructions, which may be executed by the processor 104 to provide various functionalities described herein. The computer-readable media 106 may also store information and data, such as user data or user media that is accessible through the applications, firmware, or operating system of the user device 102.

In this example, the computer-readable media 106 also includes an IPsec connection manager 108 (connection manager 108) which is described throughout the disclosure in accordance with various aspects. Generally, connection manager 108 can manage data communication connections and the seamless switching of data communication between IPsec tunnels. In some aspects, the connection manager 108 may be embodied on a System-on-Chip (SoC) and configured to manage the operation of switching IPsec tunnels seamlessly between different subsystems of the SoC. The SoC may include a multi-core processor and a memory module for real-time processing. The connection manager 108 may be configured to handle various tasks associated with seamless IPsec tunnel switching, which may include SA rekeying process to establish IPsec tunnels 112 within the same user device 102 or with an external device.

The user device 102 may also include different hardware subsystems 110, which may include any number of different hardware subsystems that may have different respective levels of power consumption, throughput, bandwidth, efficiency, or any other differences that could impact performance. In some aspects, the subsystems 110 may include or support IPSec Tunnels 112, which the user device 102 may use to exchange data with another device, network, or server. For example, the connection manager 108 may manage seamless switching of IPsec tunnels 112 to facilitate a more stateless and uninterrupted transition. In aspects, the connection manager 108 may be configured to ensure continuous service on a first IPsec tunnel while negotiating a second IPsec tunnel, as well as manage the completion of data transfer on the first IPsec tunnel before initiation and completion of the deletion of the first IPsec tunnel.

In some implementations, the subsystems 110 include transmitters 114 and receivers 116, which may be implemented separately or combined as one or more transceivers that are capable of implementing both signal-receiving and -transmitting functions. For example, respective IPsec tunnels may be established on different subsystems or communication transceivers of the user device 102 to allow concurrent communication over two channels or IPsec tunnels. The transmitters 114 and receivers 116 may be configured to communicate via any suitable type of wireless network, such as a local-area-network (LAN), a wireless local-area-network (WLAN), a personal-area-network (PAN), a wide-area-network (WAN), cellular network, a peer-to-peer network, point-to-point network, a mesh network, and so on. In some aspects, one or more of the transmitters 114 and receivers 116 are configurable to communicate in accordance with a Global System for Mobile Communications (GSM) standard, Third Generation (3G) standard, Code Division Multiple Access (CDMA), wideband CDMA (WCDMA), Universal Mobile Telephone System (UMTS), Worldwide Interoperability for Microwave Access (WiMax) protocol, High Speed Packet Access (HSPA) protocol, Evolved HSPA (HSPA+) protocol, Long-Term Evolution (LTE) standard, LTE Advanced standard, 5th Generation (5G) standard, or the like.

A radio-frequency front end 118 (RF front end 118) of the user subsystems 110 includes signal conditioning and switching circuitry that enables coupling of various ones of the transmitters 114 and receivers 116 to or with antennas 120 of the user device. The RF front end 118 may include any suitable combination of circuitry, such as filters, amplifiers (e.g., power amplifiers or low-noise amplifiers), diplexers, switches, multiplexers, baluns, or the like. The user device may also include sensors 122, which enable the user device 102 to sense various properties, variances, stimuli, or characteristics of an environment in which user device 102 operates. For example, the sensors 122 may include various motion sensors, ambient light sensors, acoustic sensors, capacitive sensors, infrared sensors, temperature sensors, radar sensors, or magnetic sensors. Alternately or additionally, the sensors 122 may enable interaction with, or receive input from, a user of user device 102, such as through touch sensing or proximity sensing.

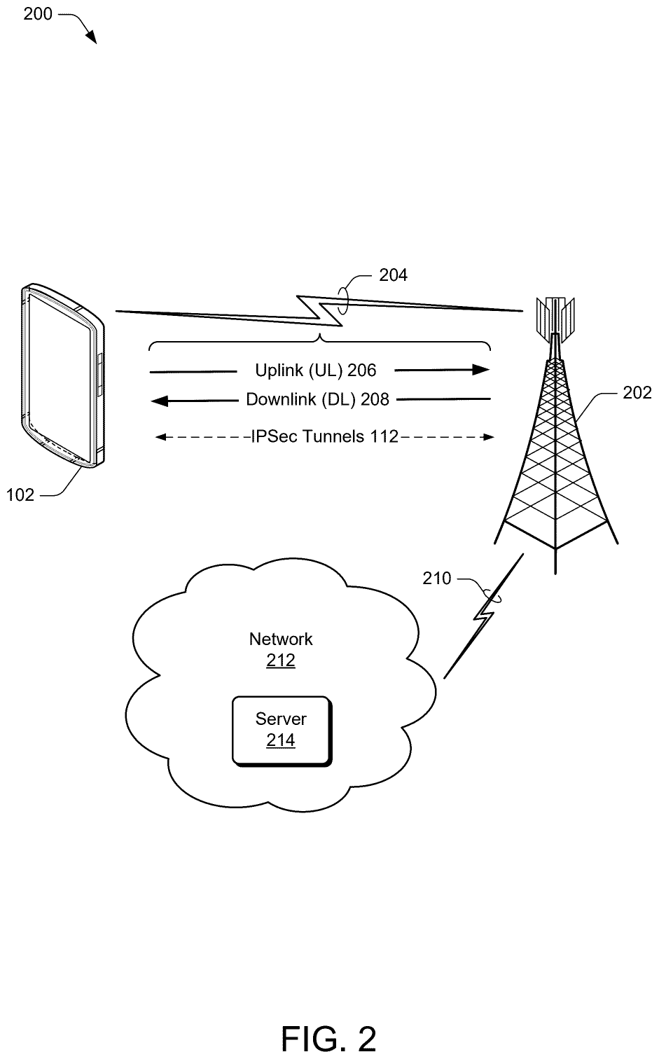

FIG. 2 illustrates an example network environment 200 in which the user device 102 communicates through a wireless network provided by a base station 202, such as an enhanced node B of an LTE network. Generally, the user device 102 communicates with the base station 202 via a wireless link 204 (or wireless connection) established or managed in accordance with various networking protocols or standards. The wireless link 204 may include an uplink 206 by which the user device 102 transmits data or control information to the base station 202 and a downlink 208 by which the base station 202 transmits data or control information to the user device 102. As noted, the wireless link 204 may be implemented in accordance with at least one suitable protocol or standard, such as a GSM standard, a WiMAX standard, an HSPA protocol, an Evolved HSPA protocol, an LTE standard, an LTE-A standard, a 5G standard, any standard promulgated or supported by the 3rd Generation Partnership Project (3GPP), and so forth. The wireless link 204 can be used for any application, such as telephone voice, message over WiFi, Google-Fi, Google-Meet, imbedded VPN service, and so forth. Although the wireless link 204 is shown or described with reference to a separate uplink 206 or downlink 208, various types of communications between the user device 102 and the base station 202 may also be referred to as a wireless communication, a wireless connection, a wireless association, a frame exchange, a communication link, or the like.

With reference to the user device 102 and as indicated by the directionality of the uplink 206 and downlink 208, the uplink 206 may include signals transmitted from the user device 102 to the base station 202. Alternately, the downlink 208 may include signals transmitted by the base station 202 for reception by the user device 102. In some cases, connection manager 108 of user device 102 configures IPsec tunnels 112. As such, the connection manager 108 of the user device 102 may configure switching the transfer of data between different systems or subsystems for IPsec tunnels 112 with service continuity. In aspects, IPsec tunnels 112 can be established over wireless link 204. In some cases, the IPsec tunnels 112 may include two separate IPsec tunnels 112 configured to support respective uplink 206 traffic and downlink 208 traffic. As noted, the IPsec tunnels 112 may be implemented in accordance with at least one suitable protocol or standard, such as a IKEv2 (RFC 7296) and IPsec (RFC 4301), and so forth. Connection manager 108 may be configured to switch data traffic between the IPsec tunnels 112 in accordance with one or more aspects.

Generally, the wireless link 204 enables the user device 102 to access resources, other networks, or other devices through the base station 202. As shown in FIG. 2, the base station 202 can provide access to a network 212 (e.g., the Internet) that is connected to the base station via a backhaul link 210 (e.g., a fiber network) or core network (not shown). The network may have a server 214 that is configured to communicate with connection manager 108 of user device 102. As such, applications or functions of the user device 102 may request or access data from the network 212 (e.g., video or voice content), which is received via signals of the downlink 208. With respect to a multi-cell wireless network, the base station 202 may be implemented to realize or manage one cell of the wireless network that includes multiple other base stations that each realize other respective cells of the wireless network. As such, the base station 202 may communicate with a network management entity, network core, or other base stations to coordinate connectivity or hand-offs of user devices within or across the cells of the wireless network.

### Example Devices and Systems

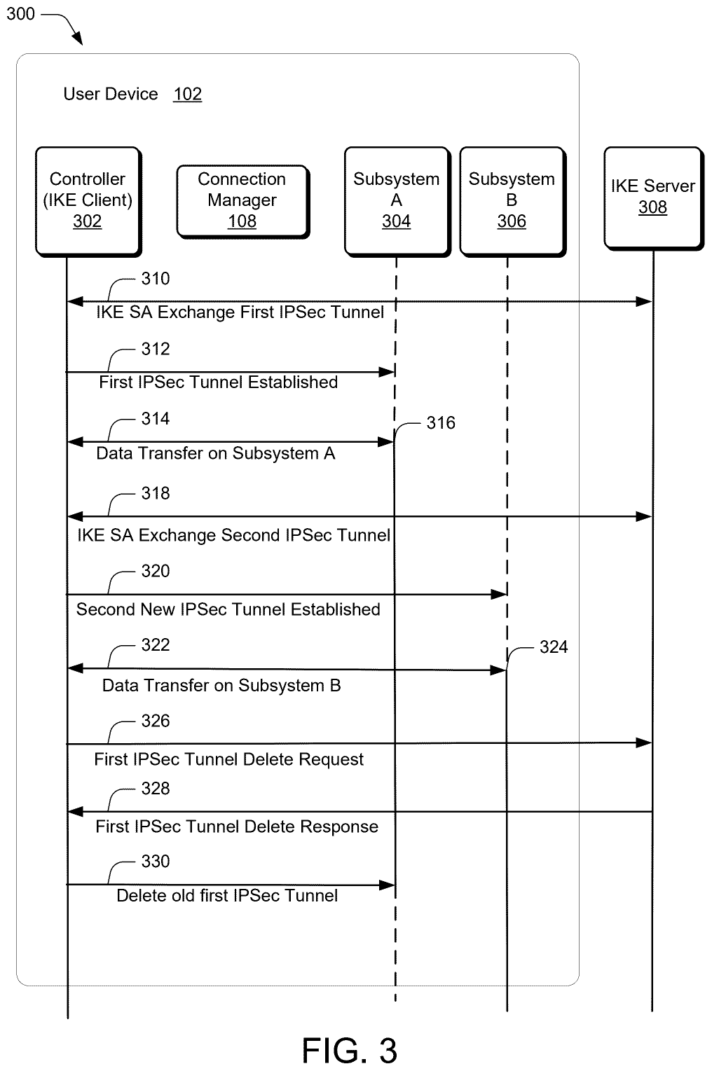

FIG. 3 illustrates at 300 an example environment in which managing and switching IPsec tunnels seamlessly between different subsystems can be implemented with one or more aspects. In various aspects, the connection manager 108 manages data transmission connections, which may include a data transmission connection between a controller (IKE Client) 302 and a IKE server 308 via subsystem A 304 and/or subsystem B 306. In some cases, the connection manager 108 is implemented as part of a chip (SoC) configured to manage the operation of a device to switch IPsec tunnels seamlessly between different subsystems of the SoC and/or the device.

In aspects, subsystem A 304 and subsystem B 306 may include hardware with different levels of performance, throughput, bandwidth, efficiency, or power usage. When the user device 102 communicates data between IKE client 302 and IKE server 308, the connection manager 108 may manage or coordinate communication of the data using a IPsec tunnel through subsystem A 304 and/or a IPsec tunnel through subsystem B 306. In one example, subsystem A 304 includes higher-power hardware that features higher performance and throughput compared to subsystem B 306, which may be configured with lower-power hardware of lower performance and throughput, while offering lower and more efficient energy consumption. Alternatively, subsystem A 304 may include lower-power hardware with lower performance and throughput compared to subsystem B 306, which may be configured as higher-power hardware of higher performance, throughput, and power consumption.

In various aspects, the connection manager 108 manages or coordinates negotiation of a first SA 310 between the IKE client 302 and IKE server 308 by establishing a first IPSec tunnel 312 through subsystem A 304. Once the first IPSec tunnel 312 has been established, the connection manager 108 can initiate data transfer 314 through subsystem A 304 and data traffic 316 begins. While the user device communicates data through subsystem A 304, the connection manager 108 can direct the IKE client 302 to initiate a rekeying process with the IKE server 308, establishing a second SA 318. Upon successful negotiation of the second SA 318, the connection manager 108 can establish a second IPSec tunnel 320 on subsystem B 306 for communication and data exchange. After establishing the second IPSec tunnel 320, the connection manager 108 directs the IKE client 302 to initiate data transfer 322 on subsystem B 306 and data traffic 324 begins through the second IPSec tunnel 320.

As shown in FIG. 3, the user device may communicate traffic 324 through subsystem B 306 as well as data traffic 316 through subsystem A 304, maintaining data transmission continuity through both IPSec tunnels without data loss. Next in this example, the connection manager 108 directs the IKE client 302 to send a tunnel delete request 326 message to the IKE server. After the user device 102 completes transferring data transfer 314 (e.g., previous data exchange) through the first IPsec tunnel 312 on subsystem A 304 and the user device establishes the new data exchange of data traffic 324 through second IPsec tunnel 320 on subsystem B 306 (e.g., handling all data traffic), the IKE client 302 can send the tunnel delete request 326 message to cause the IKE server 308 to delete the first IPsec tunnel 312 through subsystem A 304.

In some cases, the IKE server 308 processes the tunnel delete request 326 message and responds with tunnel delete response 328 message to communicate to the IKE client 302 that the first IPsec tunnel 312 through subsystem A 304 is ready for deactivation. The IKE client may then delete the first IPsec tunnel 330, completing the transmission of data traffic 316 through subsystem A 304. Throughout this process, the connection manager 108 can maintain adherence to security protocols, including sequence number integrity and anti-replay protections. In aspects, the seamless transition between previously existing and newly established SAs, facilitated by the coexistence period of the first and second IPSec tunnels, can ensure continuous and secure communication without data loss or service interruption.

### Example Methods

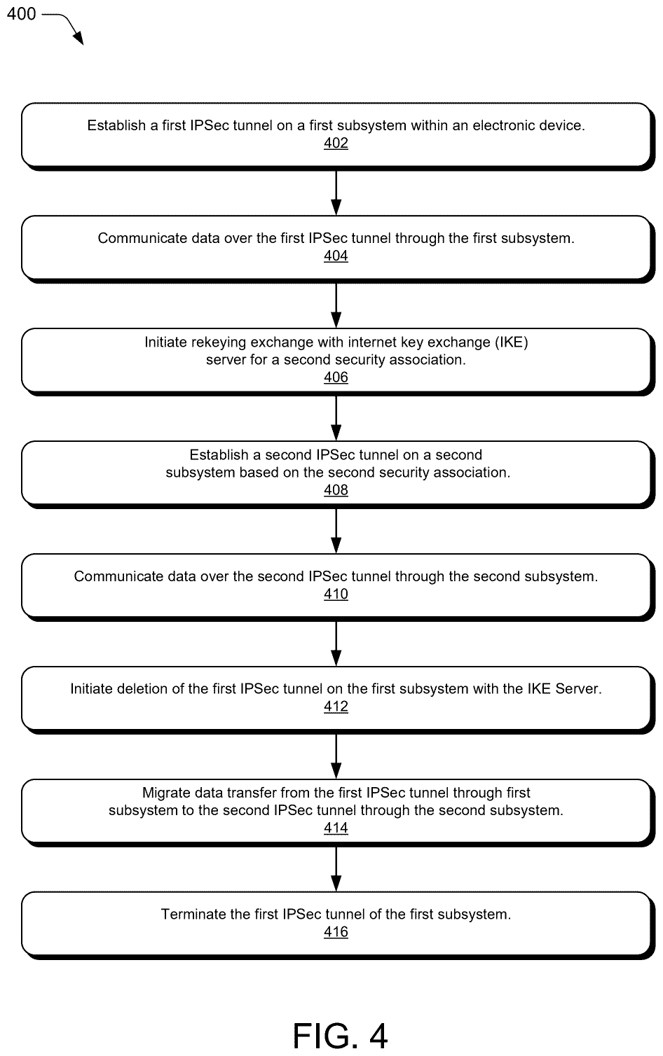

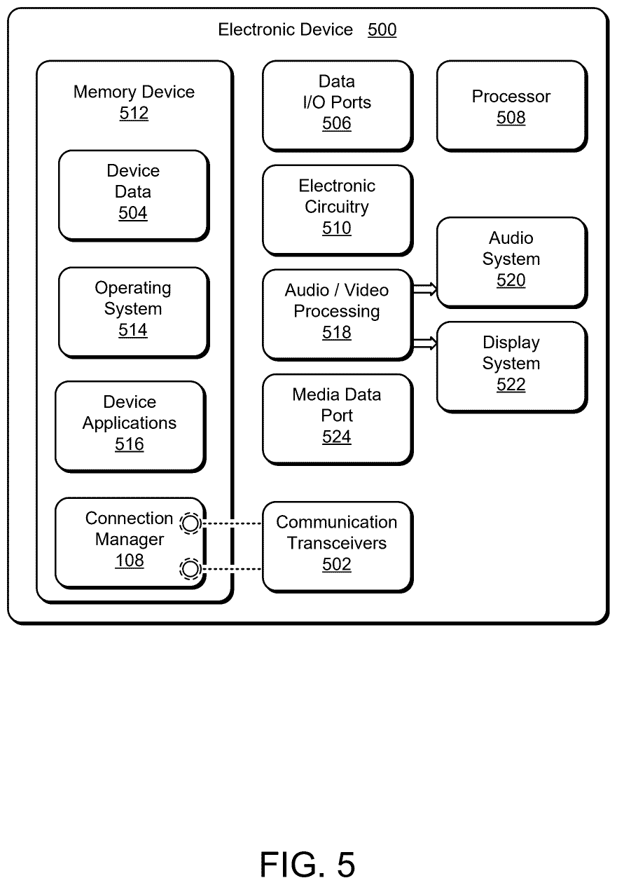

Example method 400 is described with reference to FIG. 4 in accordance with one or more aspects of switching IPsec tunnels seamlessly between different subsystems. Generally, the method 400 illustrates sets of operations (or acts) performed in, but not necessarily limited to, the order or combinations in which the operations are shown herein. Further, any of one or more of the operations may be repeated, combined, reorganized, omitted, or linked to provide a variety of additional and/or alternate methods. In portions of the following discussion, reference may be made to example FIGS. 1-3 or the example device of FIG. 5, reference to which is made for example only. The techniques and apparatuses described in this disclosure are not limited to embodiment or performance by one entity or multiple entities operating in relation to switching IPsec tunnels seamlessly between different subsystems.

FIG. 4 illustrates an example method 400 for switching IPsec tunnels 112 seamlessly between different subsystems 110 in accordance with one or more aspects. In aspects, operations of the method 400 can be implemented by or with connection manager 108, IKE client 302, and/or IKE server 308.

At 402, a connection manager of a user device establishes a first IPSec tunnel on a first subsystem within an electronic user device. The first IPSec tunnel may be implemented on any suitable type of subsystem, which may include a wired transceiver or wireless transceiver of the user device. Establishing the first IPSec tunnel may include establishing a first SA for the first IPSec tunnel on a first subsystem and initiating the communication of the data over the first IPsec tunnel on the first subsystem. After establishing the IPSec tunnel, the user device can maintain the communication of data through the first IPsec tunnel on the first subsystem using the first SA. Thus, prior to maintaining the IPSec tunnel, the connection manager may establish the first IPSec tunnel and initiate the transmission of the data over the first IPsec tunnel through the first subsystem.

At 404, the connection manager communicates data over the first IPsec tunnel through the first subsystem. Initially, subsystem A may handle most or all of the IPsec-protected communication between the user device and server or remote entity. The user device can send and/or receive the data traffic through subsystem A while the IKE client and server maintain the active tunnel. For example, a mobile device can use a higher-power subsystem to handle high data throughput while running one or more applications and/or processes that demand high performance.

At 406, the connection manager initiates a rekeying exchange with IKE server for a second SA. For example, the connection manager directs the IKE client to initiate a rekeying process by sending an IKE_CREATE_CHILD_SA exchange to the IKE server. In various implementations this, exchange includes or negotiates new cryptographic parameters and/or establishing a new child SA. During this phase, the existing SA continues to operate over the existing IPSec tunnel, ensuring uninterrupted data flow during operation 406. In some cases, the rekeying exchange with the IKE server is be triggered by one or more applications and/or processes closing on a mobile device, requiring less processing demand, and so the device may be configured to go into a lower power usage mode that uses lower performance hardware.

At 408, the connection manager establishes a second IPsec tunnel on a second subsystem based on the second SA. The second IPsec tunnel may include one or more new tunnels that can be configured with the newly negotiated cryptographic parameters and/or sequence numbers, which can start from zero. After configuration of the IPSec tunnels, subsystem B can handle traffic under the second SA while subsystem A continues to process previous or current data traffic. In context of the present example, the user device has established a data exchange tunnel with lower-power hardware, which may reduce power consumption when communicating data with the server.

At 410, the connection manager communicates data over the second IPsec tunnel through the second subsystem. The connection manager directs the IKE client to activate subsystem B, and the user device can route traffic through subsystem B using the new IPsec tunnels. During this transition, both subsystem A and subsystem B can communicate and process traffic, ensuring no loss of data and continuity of data traffic. In context of the present example, the user device can use both the higher-power and the lower-power hardware subsystems concurrently to handle data communication operations for the one or more applications or processes that are executing on the user device.

At 412, the connection manager initiates the deletion of the first IPsec tunnel on the first subsystem with the IKE server. In some cases, the connection manager directs the IKE client to send a request to delete the first IPsec tunnel on subsystem A. For example, the IKE client can send an IKE INFORMATION (DELETE) message to the IKE server 308 that indicates the intention to delete the previous IPsec tunnels on subsystem A. Generally, this message ensures the proper decommissioning of the previous SA while avoiding an abrupt termination of the IPSec tunnel that could affect data traffic.

At 414, the connection manager migrates data transfer from the first IPsec tunnel through the first subsystem to the second IPsec tunnel through the second subsystem. In context of the present example, with the new IPSec tunnels on subsystem B operational, the connection manager shifts the data traffic handling from subsystem A to subsystem B. In some cases, the IKE server processes the delete request, and any remaining data packets associated with the previous SA on subsystem A are allowed to complete their transmission. Continuing the ongoing example, the user device transfers data traffic to the lower-power hardware subsystem and terminates the SA and tunnel on the higher-power hardware subsystem, which may include instructions to complete the transmission of any active data and prepare for deactivation. By moving data traffic to the lower-power hardware subsystem, the connection manager may reduce power consumption of the user device in relation to continuing to communicate the data traffic with the server or other remote entities.

At 416, the connection manager terminates the first IPsec tunnel of the first subsystem. In the ongoing example, after transitioning the data traffic to subsystem B, the connection manager directs the IKE client to deactivate the previous tunnels on subsystem A. This step may conclude the rekeying process, ensuring that only the new tunnels on subsystem B are active to continue communication of the data traffic. Concluding the present example, the mobile device transitions the communication and data processing from the higher-power hardware subsystem A to the lower-power hardware subsystem B, and the connection manager can then deactivate the higher-power hardware subsystem, which is no longer used for processing or handling the transmission of data.

### Example Device

FIG. 5 illustrates various components of an example electronic device 500 that can implement managing and switching IPsec tunnels seamlessly between different subsystems in accordance with one or more aspects as described with reference to any of the preceding FIGS. 1-4. The electronic device 500 may be implemented as any one or a combination of a fixed or mobile device, in any form of a consumer device, computing device, portable device, user device, user equipment, server, communication device, phone, navigation device, gaming device, media device, messaging device, media player, and/or other type of electronic device or a wirelessly-enabled device. For example, the electronic device 500 may be implemented as a smart-phone, phone-tablet (phablet), laptop computer, set-top box, wireless drone, computing-glasses, vehicle-based computing system, or wireless broadband router.

The electronic device 500 includes communication transceivers 502 that enable wired and/or wireless communication of device data 504, such as received data, transmitted data, or other information as described above. Example communication transceivers 502 include NFC transceivers, WPAN radios compliant with various IEEE 802.15 standards, WLAN radios compliant with any of the various IEEE 802.11 standards, WWAN (3GPP-compliant) radios for cellular telephony, wireless metropolitan area network (WMAN) radios compliant with various IEEE 802.16 standards, and wired local area network (LAN) Ethernet transceivers.

The electronic device 500 may also include one or more data input/output ports 506 (data I/O ports 506) via which any type of data, media content, and/or other inputs can be received, such as user-selectable inputs, messages, applications, music, television content, recorded video content, and any other type of audio, video, and/or image data received from any content and/or data source. The data I/O ports 506 may include USB ports, coaxial cable ports, and other serial or parallel connectors (including internal connectors) for flash memory, DVDs, CDs, and the like. These data I/O ports 506 may be used to couple the electronic device to components, peripherals, or accessories such as keyboards, microphones, or cameras.

The electronic device 500 of this example includes at least one processor 508 (e.g., one or more application processors, processor cores microprocessors, digital-signal processors (DSPs), controllers, or the like), which can include a combined processor and memory system, that executes computer-executable instructions stored on computer-readable media to control operation or implement functionalities of the device. Generally, a processor or processing system may be implemented at least partially in hardware, which can include components of an integrated circuit or on-chip system, a DSP, an application-specific integrated circuit (ASIC), a field-programmable gate array (FPGA), a complex programmable logic device (CPLD), and other implementations in silicon and/or other hardware.

Alternately or additionally, the electronic device 500 can be implemented with any one or combination of electronic circuitry 510, which may include hardware, fixed logic circuitry, or physical interconnects (e.g., traces or connectors) that are implemented in connection with processing and control circuits. This electronic circuitry 510 can implement executable or hardware-based modules (not shown) through logic circuitry and/or hardware, such as an FPGA or CPLD. Although not shown, the electronic device 500 may also include a system bus, interconnect fabric, crossbar, or data transfer system that couples the various components within the device. A system bus or interconnect fabric can include any one or combination of different bus structures or IP blocks, such as a memory bus, memory controller, a peripheral bus, a universal serial bus, interconnect nodes, and/or a processor or local bus that utilizes any of a variety of bus architectures.

The electronic device 500 also includes one or more memory devices 512 that enable data storage, examples of which include random access memory (RAM), non-volatile memory (e.g., read-only memory (ROM), flash memory, EPROM, and EEPROM), and a disk storage device. Any or all of the memory devices 512 may enable persistent and/or non-transitory storage of information, data, or code, and thus do not include transitory signals or carrier waves in the general context of this disclosure. For example, the memory device(s) 512 provide data storage mechanisms to store the device data 504 and other types of data (e.g., user data). The memory device 512 may also store an operating system 514, firmware, and/or device applications 516 of the electronic device as instructions, code, or information. These instructions or code can be executed by the processor 508 to implement various functionalities of the electronic device, such as to provide a user interface, enable data access, or manage connectivity with a wireless network. In this example, the memory device 512 also stores processor-executable code or instructions for providing respective instance of a connection manager 108 described with reference to FIGS. 1-4. Generally, connection manager 108 can manage data communication connections and the seamless switching of data communication between IPsec tunnels. In some aspects, the connection manager 108 may be embodied on an SoC and configured to manage the operation of switching IPsec tunnels seamlessly between different subsystems of the SoC as described herein. The SoC may include a multi-core processor and a memory module for real-time processing. The connection manager 108 may be configured to handle various tasks associated with seamless IPsec tunnel switching, which may include SA rekeying process to establish IPsec tunnels within the same user device or with an external device.

As shown in FIG. 5, the electronic device 500 may include an audio and/or video processing system 518 for processing audio data and/or passing through the audio and video data to an audio system 520 and/or to a display system 522 (e.g., a video buffer or device screen). The audio system 520 and/or the display system 522 may include any devices that process, display, and/or otherwise render audio, video, graphical, and/or image data. Display data and audio signals can be communicated to an audio component and/or to a display component via an RF link, S-video link, HDMI (high-definition multimedia interface), Display Port, composite video link, component video link, DVI (digital video interface), analog audio connection, or other similar communication link, such as media data port 524. In some implementations, the audio system 520 and/or the display system 522 are external or separate components of the electronic device 500. Alternately, the display system 522 can be an integrated component of the example electronic device 500, such as part of an integrated display with touch interface.

### CONCLUSION

Although aspects of seamless switching of IPsec tunnels between subsystems have been described in language specific to features and/or methods, the subject of the appended claims is, as recited by any of the previous examples, not necessarily limited to the specific features or methods described. Rather, the specific features and methods are disclosed as example implementations of seamless switching of IPsec tunnels between subsystems, and other equivalent features and methods are intended to be within the scope of the appended claims. Further, various aspects of seamless switching of IPsec tunnels between subsystems are described, and it is to be appreciated that each described aspect can be implemented independently or in connection with one or more other described aspects.

What is claimed is:

1. A method comprising:
maintaining, on a user device, transmission of data through a first Internet Protocol security (IPsec) tunnel on a first subsystem using a first security association;
initiating, by a connection manager, a rekeying process of an internet key exchange (IKE) client with an IKE server to establish a second security association, the IKE server external to the user device;
establishing, on the user device and based on a second security association generated from the rekeying process, a second IPsec tunnel on a second subsystem, the second IPsec tunnel using the second security association;
transmitting a portion of the data through the second IPsec tunnel on the second subsystem;
initiating, by the IPsec connection manager, deactivation of the first IPsec tunnel on the first subsystem;
transitioning the transmission of the data from the first IPsec tunnel on the first subsystem to the second IPsec tunnel on the second subsystem; and
deactivating the first IPsec tunnel on the first subsystem after ceasing to transmit the data through the first IPsec tunnel on the first subsystem.

2. The method as recited in claim 1, wherein the user device concurrently transmits the data through the first IPsec tunnel on the first subsystem and the second IPsec tunnel on the second subsystem.

3. The method as recited in claim 1, wherein the IKE client activates the transmission of the portion of the data through the second IPsec tunnel on the second subsystem.

4. The method as recited in claim 1, wherein the IPsec tunnel manager directs the IKE client to initiate the deactivation of the first IPsec tunnel on the first subsystem by sending a message to the IKE server, the message indicating an intention to delete the first IPsec tunnel on the first subsystem.

5. The method as recited in claim 4, wherein in response to the message indicating the intention to delete the first IPsec tunnel on the first subsystem, the IKE server allows the first security association on the first subsystem to persist until the transmission of a remaining portion of the data completes before deactivating the first IPsec tunnel on the first subsystem.

6. The method as recited in claim 5, wherein the IKE client deactivates the first IPsec tunnel on the first subsystem in response to completing the transmission of the remaining portion of the data.

7. The method as recited in claim 1, wherein the second IPsec tunnel on the second subsystem is configured with cryptographic parameters different from cryptographic parameters of the first IPsec tunnel and an initial sequence number of zero.

8. The method as recited in claim 7, wherein the initial sequence number of zero for the second IPsec tunnel is effective to prevent a replay attack based on a sequence number of the first IPsec tunnel to access the data while being communicated through the second IPsec tunnel.

9. The method as recited in claim 1, wherein the first subsystem consumes more power to communicate the data than the second subsystem consumes to communicate the data.

10. The method as recited in claim 1, wherein the first subsystem consumes less power to communicate the data than the second subsystem consumes to communicate the data.

11. The method as recited in claim 1, wherein the first subsystem has a higher bandwidth or higher throughput for communicating the data than a bandwidth or a throughput of the second subsystem for communicating the data.

12. The method as recited in claim 1, wherein the first subsystem has a lower bandwidth or lower throughput for communicating the data than a bandwidth or a throughput of the second subsystem for communicating the data.

13. The method as recited in claim 1, wherein the IPsec connection manager ensures continuous and secure communication by maintaining sequence number integrity facilitated by a period of concurrent data transmission through both the first IPsec tunnel and data transmission through the second IPsec tunnel.

14. The method as recited in claim 1, wherein prior to maintaining the transmission of data through the first IPsec tunnel on the first subsystem using the first security association:
establishing the first IPSec tunnel on the first subsystem; and
initiating the transmission of the data over the first IPsec tunnel through the first subsystem.
